(19) United States
(12) Patent Application Publication
(10) Pub. No.: US 2022/0060463 A1
(43) Pub. Date: Feb. 24, 2022

(54) METHOD FOR MANAGING NETWORK DEVICES, APPARATUS, AND COMPUTER READABLE STORAGE MEDIUM

(71) Applicant: Shenzhen Fugui Precision Ind. Co., Ltd., Shenzhen (CN)

(72) Inventors: LIANG ZHANG, Shenzhen (CN); YAN-QING MAO, Shenzhen (CN); XIAO-YONG DUAN, Shenzhen (CN)

(21) Appl. No.: 17/133,276

(22) Filed: Dec. 23, 2020

(30) Foreign Application Priority Data
Aug. 18, 2020 (CN) 202010830954.0

(51) Int. Cl. H04L 29/06

(52) U.S. Cl. CPC H04L 63/083; H04L 63/0884

(57) ABSTRACT

A method for managing network devices, apparatus, and computer readable storage medium are disclosed. The method is applied to a management apparatus. After receiving a login request from a client device, the management apparatus first determines whether the requesting user account is in the stored user account list, and then determines whether the client device is a trusted client and whether it can pass an automatic log-in verification process. The management apparatus enables a network device management function only for a requesting user account that is trusted and which passes the automatic log-in verification process. After the user logs in to the management apparatus, subsequent verification is required to enable management of the actual network device, improving the security of other network devices through the disclosed management apparatus.

### FIELD

The subject matter herein generally relates to communication technologies.

### BACKGROUND

Currently, there are two methods for managing network devices.

One is for administrators to use the account and password of each network device to directly log in to execute management operations. However, the account and password are easily leaked and have a high risk, and once leaked, the scope of influence is large. If there are multiple administrators, since multiple administrators use the same account and password, it will be impossible to effectively control and distinguish whether each administrator can manage their own different network devices. In addition, when different network devices are being audited, it is impossible to formulate a unified access audit strategy, and it is difficult to detect illegal operations in a timely manner and to track down and collect evidence.

The other is for administrators to use an account and password for a jump server and then log in to the network device to manage the network device through the jump server. Password-free log-in to the network device is a very important function of the jump server. The administrator can preset a password through the jump server to realize password-free log-in to the network device. However, this management method requires the jump server to store the accounts and the corresponding passwords of all the network devices. Once a network device is attacked by hackers, the risk of leaking the accounts and the corresponding passwords of the network devices is very high. If the static configuration of the jump server to the network device is authorized to an administrator, once the password of the jump server is leaked or stolen, the network devices connected to the jump server will be at risk of being opened.

Thus, there is room for improvement within the art.

### BRIEF DESCRIPTION OF THE DRAWINGS

Implementations of the present technology will now be described, by way of embodiment, with reference to the attached figures, wherein:

FIG. 1 is a schematic environment diagram of one embodiment of a management apparatus for managing network devices.

FIG. 2 is a flow chart of one embodiment of a method for managing network devices.

FIG. 3 is a flow chart of another embodiment of a method for managing network devices.

FIG. 4 is a flow chart of another embodiment of a method for managing network devices.

FIG. 5 is a block diagram of another embodiment of a management apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

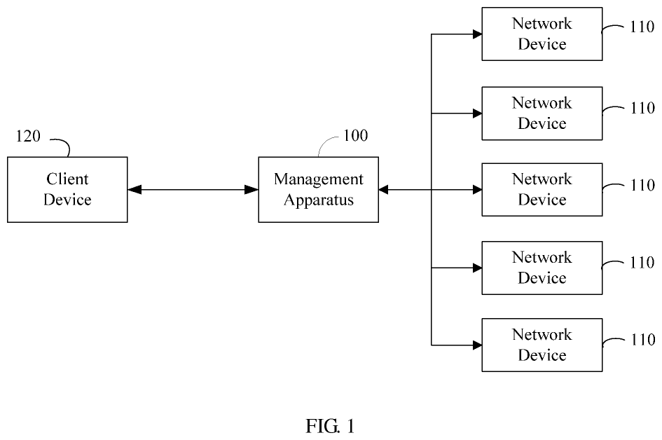

FIG. 1 illustrates a management apparatus 100 according to an embodiment. The management apparatus 100 is in communication connection with at least one network device 110 and a client device 120. A user establishes a communication with the management apparatus 100 through the client device 120, and the management apparatus 100 audits the client device as to whether the client device 120 has the authority to manage the network device 110. If the management apparatus 100 determines that the client device 120 has the authority, the client device 120 is allowed to manage the network device 110 through the management apparatus 100. In the embodiment, the management apparatus 100 may be a jumper server, a bastion host, or other computer devices that can connect to and manage the network device 110. The client device 120 may be a computer device such as a personal computer, a tablet computer, or a smart phone. The administrators of the management device 100 may be operators, maintainers, developers, system administrators, and the like. In one embodiment, for security purposes, the network device management function for administrators is disabled. That is, the administrators cannot manage the network devices directly.

In one embodiment, a background management system is running on the management apparatus 100, and the administrator can preset rules for authorization through the background management system. Specifically, the administrator can create a role or user type configuration file in advance through the background management system, and each role in the role configuration file can be configured with one or more different permissions. The administrator can also create a list of user accounts and a list of network devices in advance through the background management system. In the embodiment, each of the user accounts is a personal account configured by the administrator for each user. When a user account is added to the list of user accounts, tags are configured and applied to the user account according to the user's job responsibilities and projects, and a role or type in the role configuration file is assigned to the user account. When the network device 110 is added to the list of network devices, tags are configured to the network device 110 according to the functionality and the permitted projects of the network device 110. In this embodiment, the label is an item label, but in other embodiments, the label may be another label format that can be used to group users and network devices for group management and/or authority management. In practical applications, the management device 100 authorizes a user account according to the permissions of the role or type of the user account, as configured in the role configuration file. When the administrator wants to change the authorization rules, he can amend the role configuration file directly. The permissions corresponding to the roles in the role configuration file are used by the management apparatus 100 to apply authorization tests corresponding to the user account.

In one embodiment, when adding the network device 110, the administrator first establishes a wired or wireless connection to the management apparatus 100 and then adds the network device 110 to the list of network devices. At this stage, the connection between the management apparatus 100 and the network device 110 is called a shadow connection, a shadow connection does not allow the administrator of the management apparatus 100 to manage the network device 110 through the shadow connection. The shadow connection only allows the administrator of the management apparatus 100 to perform heartbeat detection for the network device 110. In this embodiment, the administrator can perform heartbeat detection for the network device 110 on the management device 100 through the background management system. The management apparatus 100 sends a heartbeat packet to the network device 110 and checks whether a response packet is received or not received from the network device 110. A response packet sent by the network device 110 allows the management apparatus 100 to determine that the network device 110 is available. In one embodiment, the heartbeat packet and the response packet for the heartbeat packet are both data packets in a predefined packet format. In another embodiment, the management apparatus 100 may periodically perform heartbeat detection for the network device 110 for which the shadow connection is already established.

In one embodiment, the management apparatus 100 matches user accounts and network devices according to tags, and performs user authorization according to preset authorization rules configured in the role configuration file. The authorization is a first-time authorization, also called a shadow authorization, which is an invisible authorization for the user. At this stage, the user does not have the actual authority to manage the matched network devices.

In one embodiment, the user enters a user account through a graphical user interface of the client device 120 to log in the management apparatus 100, and the management apparatus 100 receives a request to recognize the user account from the client device 120 and determines whether the received user account exists in the list of user accounts or not. If the management apparatus 100 determines that the user account so requested does not exist in the list of user accounts, the log-in request of the client device 120 is rejected. If the management apparatus 100 determines that the user account exists in the list of user accounts, the log-in request of the client device 120 is accepted, and the management apparatus 100 further matches the user account and the network devices according to the label of the user account in list the of user accounts and the labels of the network devices in the list of network devices, to determine one or more network devices 110 that the user account can manage. The management apparatus 100 also automatically authorizes the client device 120 according to the role of the user account in the list of user accounts and one or more permissions corresponding to the role in the role configuration file. This authorization is the first-time authorization, also called a shadow authorization, which is an invisible authorization for the user. At this time, the user does not have the actual authority to manage the matched network device 110. In another embodiment, when the user requests a log-in, the user may simultaneously use short message authentication, multi-factor authentication (MFA), or OAuth log-in for identity verification.

In an embodiment, the management apparatus 100 then performs a trust verification for the logged-in client device 120. Specifically, the trust verification may be a sequential verification method, or verification by the administrator, or verification by policy rules. The management apparatus 100 sends a randomly generated password which is binding to the user account to the client device 120 that has passed the trust verification. In one embodiment, a unique verification string, the IP address, the location, the browser information, or other client information of the client device 120 can be used to bind with the user account in an automatic log-in verification process for subsequent log-ins of the user. In one embodiment, the user may enter the unique verification string for verification in the future log-ins through the client device 120, or use client information of the client device 120 to automatically compare and verify, or use a combination of unique verification serial and client information of the client device 120 for verification. In one embodiment, the unique verification string can be updated and delivered to the client device 120 regularly or from time to time by the administrator.

The client device 120 that fails the trust verification only obtains the first-time authorization (shadow authorization), and the user has no actual authority to manage the network device 110.

The management apparatus 100 performs a second-time authorization for the client device 120 that has passed the trust verification, which is also called a temporary authorization. The apparatus 100 triggers a connection between the client 120 and the network device 110. At this time, the user has the authority to actually manage the one or more matched network devices 110. Once the user logs out from the management apparatus 100, the management apparatus 100 disconnects the connection with the client device 120, and disconnects the connection with the network device 110 which is established for the client 120 device. Only the first-time authorization (shadow authorization) is reserved for the user account.

In one embodiment, the management apparatus 100 performs encryption processing on the device information of all connected network devices 110, such as IP addresses, user accounts, and user passwords, etc.

In one embodiment, in order to ensure maximum availability of the management apparatus 100, the client device 120 may add an access whitelist to the managed network device 110 for better security, and only allow the few trusted servers which comprise the managed network device 110 to communicate with the managed network device 110.

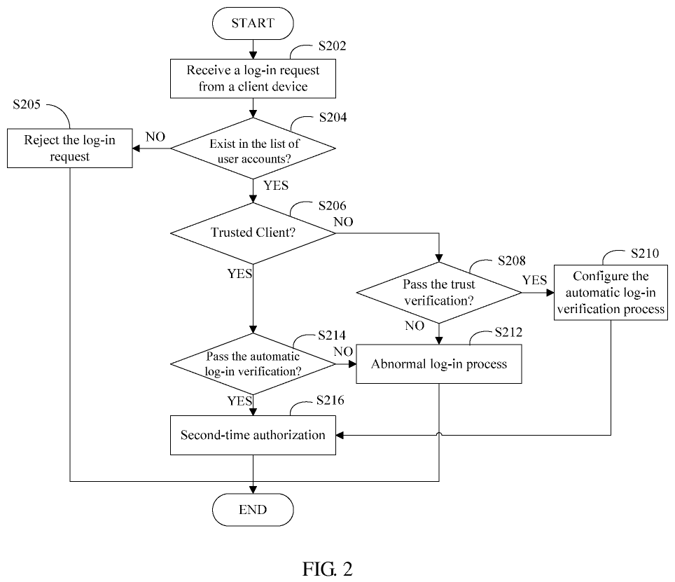

FIG. 2 illustrates a flow chart of a method for managing one or more network devices 110 according to an embodiment. The method is applied in the management apparatus 100, and the steps of the method are as follows:

Step S202, the management apparatus 100 receives a log-in request comprising log-in information from the client device 120. In one embodiment, the log-in information comprises a user account and client information. In one embodiment, the client information comprises IP address, geographic location, and browser information.

Step S204, the management apparatus 100 determines whether the user account of the log-in request exists in the list of user accounts. If the management apparatus 100 determines that the user account does not exist in the list of user accounts, step S205 is executed. If the management apparatus 100 determines that the user account exists in the list of user accounts, step S206 is executed.

Step S205, the management apparatus 100 rejects the log-in request from the client device 120.

Step S206, the management apparatus 100 determines whether the client device 120 is a trusted client. If the management apparatus 100 determines that the client device 120 is not a trusted client, step S208 is executed. If the management apparatus 100 determines that the client device 120 is not a trusted client, step S214 is executed. In one embodiment, if the client device 120 has passed the trust verification, the management apparatus 100 determines that the client device 120 is a trusted client, but if the client device 120 has not passed the trust verification, the management apparatus 100 determines that the client device 120 is not a trusted client. In one embodiment, if the client device 120 has passes the trust verification, the corresponding user account is marked as trustworthy in the list of user accounts.

Step S208, the management apparatus 100 performs trust verification for the client device 120 and determines whether the client device 120 passes the trust verification. In one embodiment, the trust verification may be a preset verification method, or verification by the administrator, or verification by policy rules. For example, the preset verification method may be to verify the user client 120 through a third-party verification agency. If the management apparatus 100 determines that the client device 120 has passed the trust verification, step S210 is executed. If the management apparatus determines that the client device 120 has failed the trust verification, step S212 is executed.

Step S210, the management apparatus 100 configures an automatic log-in verification process for future log-ins for the trusted client device 120. In one embodiment, the manage apparatus 100 randomly generates a unique verification string which is bonded with the user account of the client device 120, delivers the unique verification string to the client device 120, and stores the unique verification string and the client information with the user account in the list of user accounts. The client information comprises the IP address, the geographic location, the browser information, or other client information that can be used to identify the client device 120. After receiving the unique verification string, the client device 120 notifies user to select an automatic log-in verification process, and transmits to the management apparatus 100 the automatic log-in verification process selected by the user of the client device 120. The management apparatus 100 configures the automatic log-in process selected by the user for the trusted client device 120. In one embodiment, the management apparatus 100 may store in the list of user accounts the unique verification string bonded or bound to the user account, the client information corresponding to the user account, and the automatic log-in mode selected by the user account. In one embodiment, the automatic log-in verification process comprises comparing whether the character string sent by the client device 120 matches the unique verification character string bonded to the user account of the client device 120, or comparing whether the client information of the client device 120 matches the client information bonded to the user account of the client device 120, or compares both the character string sent by the client device 120 and the client information of the client device 120.

Step S212, the management apparatus 100 marks the log-in request of the client device 120 as an abnormal log-in, and performs an abnormality report. In one embodiment, the abnormality report comprises notifying the administrator and/or issuing an alarm.

Step S214, since the client device 120 is a trusted client, the management apparatus 100 performs the automatic log-in verification process according to the automatic log-in verification process of the user account. If the client device 120 fails the automatic log-in verification, it means that the client device 120 is a trusted client, but the sent character string does not match the stored unique verification string and/or the client information does not match the stored client information. At this time, the management apparatus 100 marks the log-in of the client device 120 as abnormal, and executes step S212. If the client device 120 passes the automatic log-in verification, the management apparatus 100 executes step S216.

Step S216, the management apparatus 100 perform the second-time authorization for the client device 120 to enable a network device management function for the user account of the client device 120.

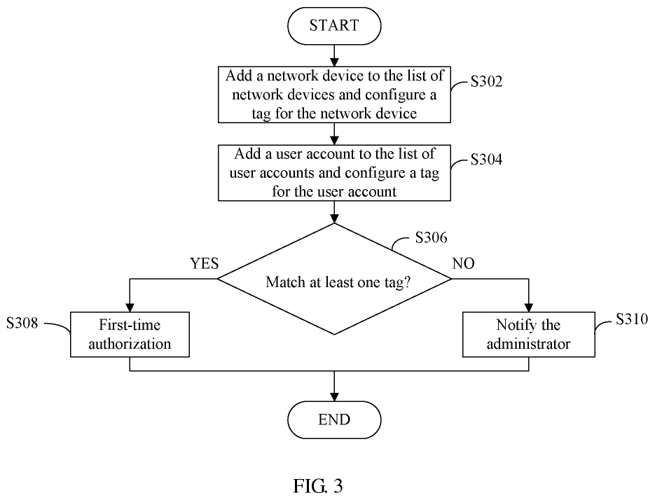

FIG. 3 illustrates a flow chart of a method for managing one or more network devices 110 according to another embodiment. The method is applied in the management apparatus 100, and the steps of the method may be executed before the steps shown in FIG. 2. The steps of the method are as follows:

Step S302, when there is a new network device, the management apparatus 100 adds the new network device to the list of the network devices, and configures a tag to the new network device according to the functionality and the projects of the network device 110.

Step S304, when there is a new user, the management apparatus 100 adds a user account corresponding to the new user to the list of user accounts, and configures a tag to the user account according to the new user's job responsibilities and permitted projects.

Step S306, the management apparatus 100 determines whether the tag of the user account match at least one tag in the list of network devices. If the management apparatus 100 determines that at least one tag of the user account does match, step S308 is executed, otherwise step S310 is executed.

Step S308, the management apparatus 100 performs an authorization for the user account according to a preset authorization rule, establishes a relationship of permissions associated with and between the user account and the network device 110 corresponding to the at least one matched tag, and disables the network device management function for the user account. In one embodiment, the preset authorization rule is configured in the role configuration file, and each role in the role configuration file is configured with one or more permissions. When a user account is added to the list of user accounts, a role is assigned to the user account by the management apparatus 100, so as to configure the corresponding authority for the user account through the relationship of permissions such as the authority corresponding to the user account and the tag matching.

Step S310, If the management apparatus 100 determines that the tag of the user account does not match any tag in the list of network devices, meaning that the user account does not have any manageable network device, the management apparatus notifies the administrator.

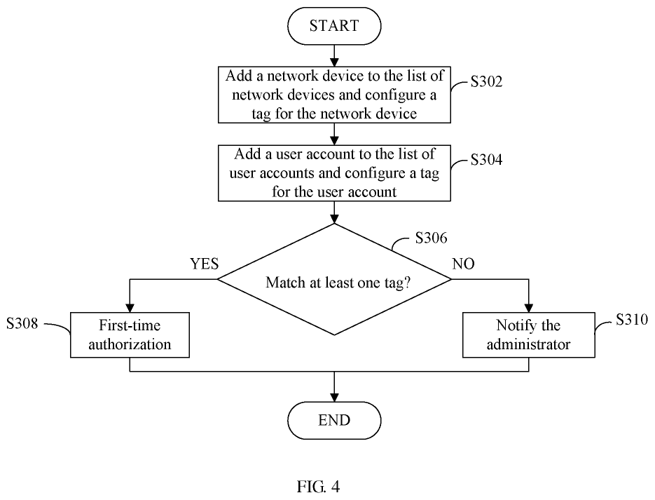

FIG. 4 illustrates a flow chart of a method for managing one or more network devices 110 according to another embodiment. The method is applied in the management apparatus 100, and the steps of the method may be executed after the steps shown in FIG. 2. The steps of the method are as follows:

Step S402, the management apparatus 100 receives a log-out request of the user account sent by the client device 120.

Step S404, the management apparatus 100 maintains a first-time authorization for the user account, that is, the management apparatus 100 maintains the relationship of permissions between the user account and the at least one managed network device, and disables the network device management function of the user account.

Step S406, the manage apparatus 100 disconnects the connection with the client device 120.

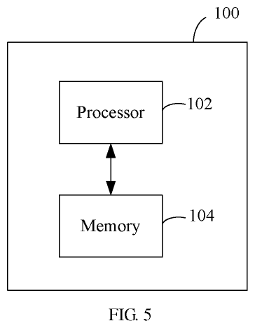

FIG. 5 illustrates a block diagram of the management apparatus 100 according to one embodiment. The management apparatus 100 may also be a network device. As shown in FIG. 5, the management apparatus 100 may include one or more processors 102 (only one is illustrated in the figure) and a memory 104 configured to store data. The processor 102 comprises, but not limited to, a processing device such as a Micro Control Unit (MCU) or a Field Programmable Gate Array (FPGA). The memory 104 may be configured to store software programs of application software and modules, for example, program instructions/modules corresponding to the methods in the embodiments of the disclosure. The processor 102 runs the software programs and modules stored in the memory 104, thereby executing various functional applications and data processing, namely implementing the abovementioned methods. The memory 104 may comprise a high-speed random access memory and may also comprise a nonvolatile memory, for example, one or more magnetic storage devices, flash memories, or other nonvolatile solid-state memories. In another embodiment, the memory 104 may further comprise a memory arranged remotely relative to the processor 102 and the remote memory may be connected to the management apparatus 100 through another network. An example of the other network includes, but is not limited to, the Internet, an intranet, a local area network, a mobile communication network, and a combination thereof. In another embodiment, the management apparatus 100 may further include more or less components than the components shown in FIG. 5 or have a configuration different from that shown in FIG. 5.

The network device management method, apparatus, and computer-readable storage medium of the disclosure can automatically match user accounts and network devices according to configured tags, and perform first-time authorization according to preset authorization rules, reducing manual configuration steps for administrators. For the first-time authorized client, the trust verification and the second-time authorization are performed, and it is only when the client receives second-time authorization that the network device management function is enabled, thus enhancing the security of network device management.

The embodiments shown and described above are only examples. Many details are often found in the art such as the other features of the management apparatus 100. Therefore, many such details are neither shown nor described. Even though numerous characteristics and advantages of the present technology have been set forth in the foregoing description, together with details of the structure and functions of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for managing network devices applied in a management apparatus, wherein a list of network devices communicatively connected to the management apparatus and a list of user accounts are stored in the management apparatus, the method comprising:
receiving a log-in request comprising log-in information from a client device, wherein the log-in information comprises a user account and client information;
determining whether the user account exists in the list of user accounts;
rejecting the log-in request when it is determined that the user account does not exist in the list of user accounts;
determining whether the client device is a trusted client when it is determined that the user account exists in the list of user accounts;
performing a trust verification for the client device and determining whether the client device passes the trust verification when it is determined that the client device is not a trusted client;
configuring an automatic log-in verification process for future log-ins for the client device by randomly generating a unique verification string which is bonded with the use account, delivering the unique verification string to the client device, storing the unique verification string and the client information with the user account in the list of user accounts, and performing a second-time authorization for the client device to enable a network device management function for the user account when it is determined that the client device has passed the trust verification; marking the log-in request of the client device as an abnormal log-in and performing an abnormal report when it is determined that the client device does not pass the trust verification;
performing the automatic log-in verification process for the client device and determining whether the client device passes the automatic log-in verification process when it is determined that the client device is a trusted client;
marking the log-in request of the client device as the abnormal log-in and performing the abnormal report when it is determined that the client device does not pass the automatic log-in verification process; and
performing the second-time authorization for the client device to enable the network device management function for the user account of the client device when it is determined that the client device has passed the automatic log-in verification process.

2. The method of claim 1, wherein trust verification comprises:
verification the client device by a third-party verification agency; and
verification the client device by an administrator of the management apparatus.

3. The method of claim 1, wherein the client information comprises IP address, geographic location, and browser information.

4. The method of claim 1, wherein the automatic log-in verification process comprises:
comparing whether a character string sent by the client device is matched the unique verification string of the user account in the list of user accounts; and
comparing whether the client information of the log-in request is matched the client information of the user account in the list of user accounts.

5. The method of claim 1, further comprising:
adding a new network device to the list of network devices; and
configuring a tag to the new network device according to a functionality and projects of the network device.

6. The method of claim 5, further comprising:
adding a new user account to the list of user accounts;
configuring a tag to the new user account according to job responsibilities and permitted projects of the new user account;
determining whether the tag of the new user account matches any tags of the network devices in the list of network devices;
performing a first-time authorization by establishing a relationship of permissions associated with and between the new user account and at least one matched network device according to a preset authorization rule if it is determined that the tag of the new user account matches at least one tag in the list of network devices; and
notifying an administrator of the management apparatus if it is determined that the tag of the new user account does not match any tags of the network devices in the list of network devices.

7. The method of claim 1, further comprising:
receiving a log-out request from the client device;
disabling the network device management function of the user account of the client device; and
disconnecting with the client device.

8. The method of claim 1, further comprising:
performing heartbeat detection for all the network devices communicatively connected to the manage apparatus;
disabling the network device management function for an administrator of the management apparatus.

9. A management apparatus for managing network devices, comprising: a memory storing instructions, a list of network devices communicatively connected to the management apparatus and a list of user accounts; and a processor coupled to the memory and, when executing the instructions, configured for:
receiving a log-in request comprising log-in information from a client device, wherein the log-in information comprises a user account and client information;
determining whether the user account exists in the list of user accounts;
rejecting the log-in request when it is determined that the user account does not exist in the list of user accounts;
determining whether the client device is a trusted client when it is determined that the user account exists in the list of user accounts;
performing a trust verification for the client device and determining whether the client device passes the trust verification when it is determined that the client device is not a trusted client;
configuring an automatic log-in verification process for future log-ins the client device by generating a unique verification string which is bonded with the user account, delivering the unique verification string to the client device, storing the unique verification string and the client information with the user account in the list of user accounts, and performing a second-time authorization for the client device to enable a network device management function of the client device for the user account when it is determined that the client device has passed the trust verification;
marking the log-in request of the client device as an abnormal log-in and performing an abnormal report when it is determined that the client device does not pass the trust verification;
performing the automatic log-in verification process for the client device and determining whether the client device passes the automatic log-in verification process when it is determined that the client device is a trusted client;
marking the log-in request of the client device as the abnormal log-in and performing the abnormal report when it is determined that the client device does not pass the automatic log-in verification process; and
performing the second-time authorization for the client device to enable the network device management function for the user account of the client device when it is determined that the client device has passed the automatic log-in verification process.

10. The management apparatus of claim 9, wherein the processor is further configured for:
adding a new network device to the list of network devices; and
configuring a tag to the new network device according to a functionality and projects of the network device.

11. The management apparatus of claim 10, wherein the processor is further configured for:
adding a new user account to the list of user accounts;
configuring a tag to the new user account according to job responsibilities and permitted projects of the new user account;
determining whether the tag of the new user account matches any tags of the network devices in the list of network devices;
performing a first-time authorization by establishing a relationship of permissions associated with and between the new user account and at least one matched network device according to a preset authorization rule if it is determined that the tag of the new user account matches at least one tag in the list of network devices; and
notifying an administrator of the management apparatus if it is determined that the tag of the new user account does not match any tags of the network devices in the list of network devices.

12. The management apparatus of claim 9, wherein the processor is further configured for:
receiving a log-out request from the client device;
disabling the network device management function of the user account of the client device; and
disconnecting with client device.

13. The management apparatus of claim 9, wherein the processor is further configured for:
receiving a log-out request from the client device;
disabling the network device management function of the user account of the client device; and
disconnecting with the client device.

14. The management apparatus of claim 9, wherein the processor is further configured for:
performing heartbeat detection for all the network devices communicatively connected to the manage apparatus;
disabling the network device management function for an administrator of the management apparatus.

15. A computer readable storage medium, in which computer-executable instructions are stored, the computer-executable instructions being executed by a processor to implement the following operations:
receiving a log-in request comprising log-in information from a client device, wherein the log-in information comprises a user account and client information;
determining whether the user account exists in a list of user accounts;
rejecting the log-in request when it is determined that the user account does not exist in the list of user accounts;
determining whether the client device is a trusted client when it is determined that the user account exists in the list of user accounts;
performing a trust verification for the client device and determining whether the client device passes the trust verification when it is determined that the client device is not a trusted client;
configuring an automatic log-in verification process for future log-ins the client device by randomly generating a unique verification string which is bonded with the user account, delivering the unique verification string to the client device, storing the unique verification string and the client information with the user account in the list of user accounts, and performing a second-time authorization for the client device to enable a network device management function for the user account of the client device when it is determined that the client device has passed the trust verification;
marking the log-in request of the client device as an abnormal log-in and performing an abnormal report when it is determined that the client device does not pass the trust verification;
performing the automatic log-in verification process for the client device and determining whether the client device passes the automatic log-in verification process when it is determined that the client device is a trusted client;
marking the log-in request of the client device as the abnormal log-in and performing the abnormal report when it is determined that the client device does not pass the automatic log-in verification process; and
performing the second-time authorization for the client device to enable the network device management function of the client device when it is determined that the client device has passed the automatic log-in verification process.
